(19) United States
(12) Patent Application Publication
(10) Pub. No.: US 2019/0303825 A1
(43) Pub. Date: Oct. 3, 2019

(54) Healthcare Project Management process

(71) Applicants: Lynell J. De Wind, Berrien Springs, MI (US); Robin Sarkar, St Joseph, MI (US)

(72) Inventors: Lynell J. De Wind, Berrien Springs, MI (US); Robin Sarkar, St Joseph, MI (US)

(21) Appl. No.: 15/942,649

(22) Filed: Apr. 2, 2018

(51) Int. Cl. G06Q 10/06

(52) U.S. Cl. CPC G06Q 10/06313

(57) ABSTRACT

Project management strategies for information technology in healthcare have to balance between competing priorities. Projects that impact patient care have to be weighed against information security and compliance initiatives. Within this realm is the opportunity to lose sight of the overall impact to the patient's experience. This new process relies on the restating of the “heartfelt why” at every phase of the project process:
Project intake and prioritization
Explore: determine needed resources and feasibility
Plan: development of detailed project plan with identified resources
Execute: deployment of the project plan with frequent stakeholder communications
Deliver: complete the build/execute tasks and deliver the project to end users
Post-Implementation Review: Performed three to six most after implementation to compare actual performance with anticipated project benefits identified in the explore phase.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Enterprise planning and visual representations of project processes

Resources, workflows, human or project management, e.g. organizing, planning, scheduling or allocating time, human or machine resources; Enterprise planning; Organizational models

### BACKGROUND OF THE INVENTION

Healthcare is uniquely poised where sharing is expected and motivation for improvement is compelling. In this space there are new ideas surfacing that call for an agile, yet thorough evaluation to determine effectiveness, balanced with patient safety, information security and compliance alignment. Sorting through the incoming ideas has created an opportunity to create a fresh take on project management applied specifically in the health care environment. Project Management with a Heart incorporates a “heartfelt why” into each stage from project inception to post-implementation review to place patient care in the center of every project.
Placing care in the center of projects
Creating simple tools to track project progress
Shifting the culture from “doing all things” to “doing vetted projects well”

Prior to this program, intake of project work was haphazard and created conflicts when scarce resources were double, or even triple booked. Delivery dates were hard to set and disappointment with project performance was prevalent. The tools created for this invention helped to streamline the intake process, developed stage gates for each project phase and increased end user satisfaction by setting realistic expectations and delivery quality results.

Building upon previous construction project management patent, US 2013/0132440 May 3013, this submission seeks to provide a concise, relevant project management process within healthcare settings.

### BRIEF SUMMARY OF THE INVENTION

Distilling the project management process into the following categories:

Project intake and prioritization
Explore: determine needed resources and feasibility
Plan: development of detailed project plan with identified resources
Execute: deployment of the project plan with frequent stakeholder communications
Deliver: complete the build/execute tasks and deliver the project to end users
Post-Implementation Review: Performed three to six most after implementation to compare actual performance with anticipated project benefits identified in the explore phase.

With the number of technology enhancements available in the health care environment, the IT department was challenged with balancing multiple requests with an informal project intake process. Which project should we pursue? Which project would result in the best outcome? How do you insure that the delivered enhancement is actually used? How do you balance multiple requests with limited resources?

In order to ensure strategic alignment, a review of unfunded ideas for technical feasibility is performed via a cross-functional meeting. During those conversations, the scope and patient impact are discussed. By shifting the conversation toward patient-impact, priorities are clearer and outcomes easier to define. After funding is obtained, the project would then be reviewed in a cross-functional meeting as the project moved from Explore to Plan to Execute and finally to Deliver project phases. The multiple reviews ensured that the right efforts were being put toward the right projects, at the right time. The ability to see all the projects in a “1-page” portfolio view allows new ideas to be easily be compared with current work load. This view shows a red, yellow, green workload designation to balance complex projects with more simple project. It aids in the trade off conversations as managers seek to understand where to put scare resources. The heartfelt why for each project is reflected in monthly status updates made available to stakeholders. It is a visible reminder to team members about the importance and the impact of their project work.

### BRIEF DESCRIPTION OF THE SEVERAL VIEWS OF THE DRAWING

FIG. 1A: Project Intake Process

FIG. 1B: Project Acceptance Process

FIG. 1C: Capacity and Timeline decisions

FIG. 2A: Project Phases

FIG. 2B: Explore Phase Checklist

Phase 2C: Plan Phase Checklist

Phase 2D: Execute Phase Checklist

Phase 2E: Deliver Phase Checklist

FIG. 3A: Project Request Form

FIG. 3B: Project Status Update Form

FIG. 3C: Project Portfolio Overview

### DETAILED DESCRIPTION OF THE INVENTION

Healthcare is uniquely poised where sharing is expected and motivation for improvements is compelling. In this space there are always new ideas surfacing that call for an agile, yet thorough evaluation to determine effectiveness balanced with patient safety, information security and compliance alignment. Sorting through the variety and complexity of the incoming ideas has created an opportunity to create a fresh take on project management applied specifically in the health care environment. This new methodology places patient care in the center. Project Management with a Heart incorporates a “heartfelt why” into each stage from project inception to post-implementation review.

This is most clearly seen through linking of forms and processes to provide a “whole” system that consistently keeps the heartfelt why in the center of the conversation as the project moves through the phases.

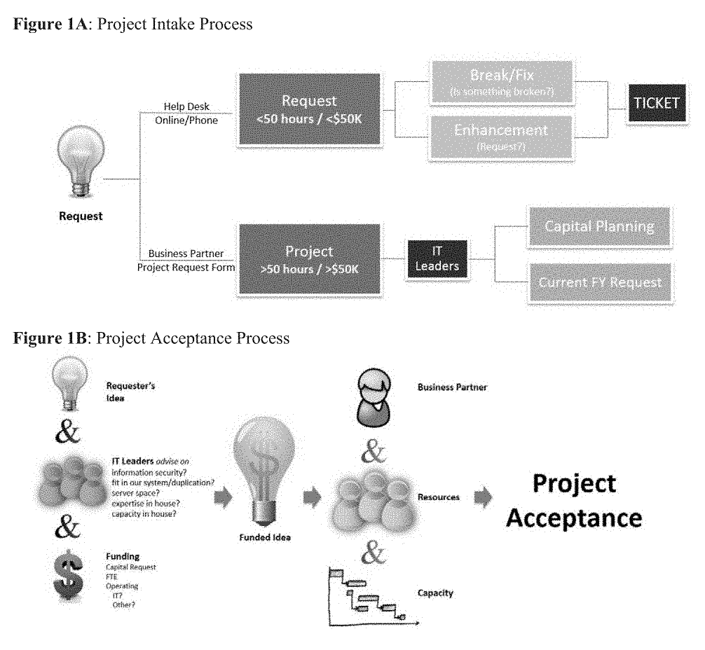

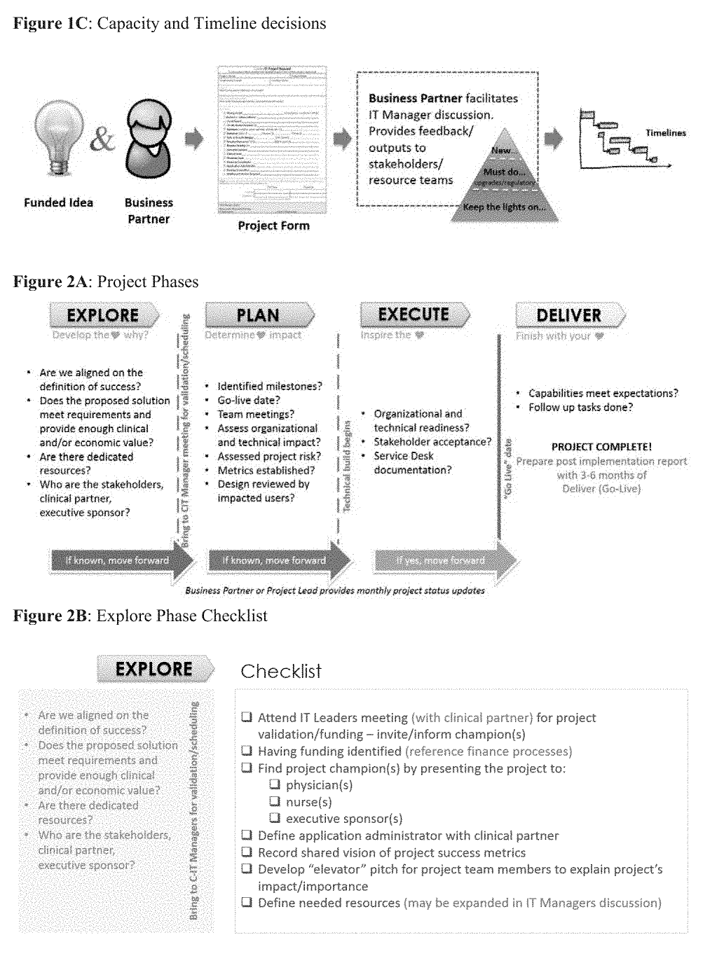

The project intake process is FIG. 1A.

Once a request is deemed a project (versus a request), the idea is shepherded through the rest of the process utilizing a business partner. This business partner is a manager in IT that will advocate for the idea and provide specific feedback to stakeholders as the project moves through the vetting process. Capacity decisions are made by IT leaders reviewing new ideas balanced with current workloads.

The project acceptance process is FIG. 1B.
Capacity and timeline decisions are reflected in FIG. 1C.

Projects follow a four-phase process with specific conversations with IT leaders as projects move from phase to phase. A more detailed checklist is available to help inform the IT leaders conversations as the project moves between phases.

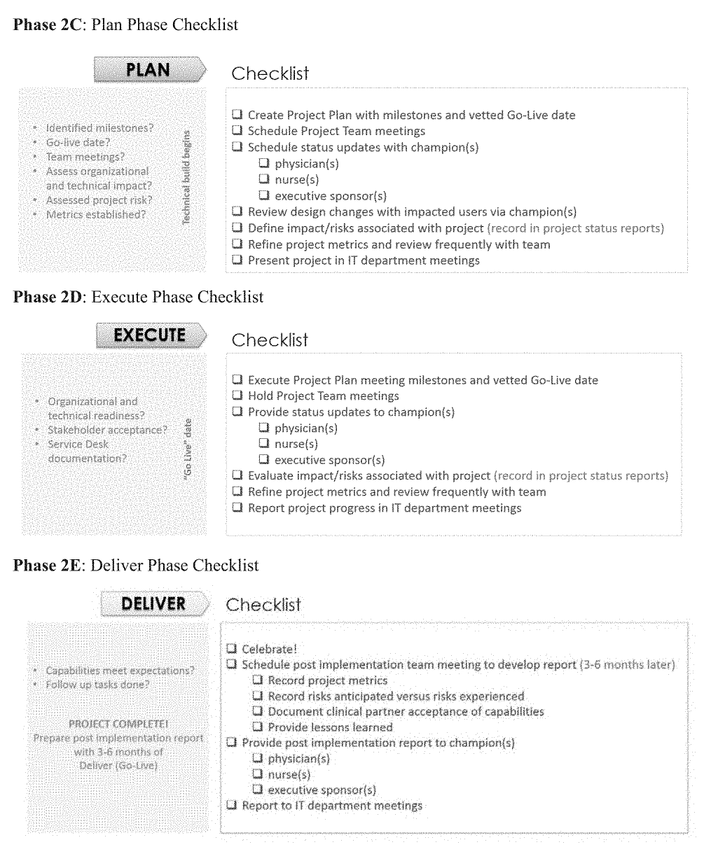

Project phases is FIG. 2A
Example of detailed checklist is FIG. 2B, 2C, 2D, 2E

Several supporting documents help communicate project details and status as the project moves through the phases. The project request form helps with “pre-explore” processes by gathering known details into one space. Communicating with IT leaders and project stakeholders is done via a project status update form.

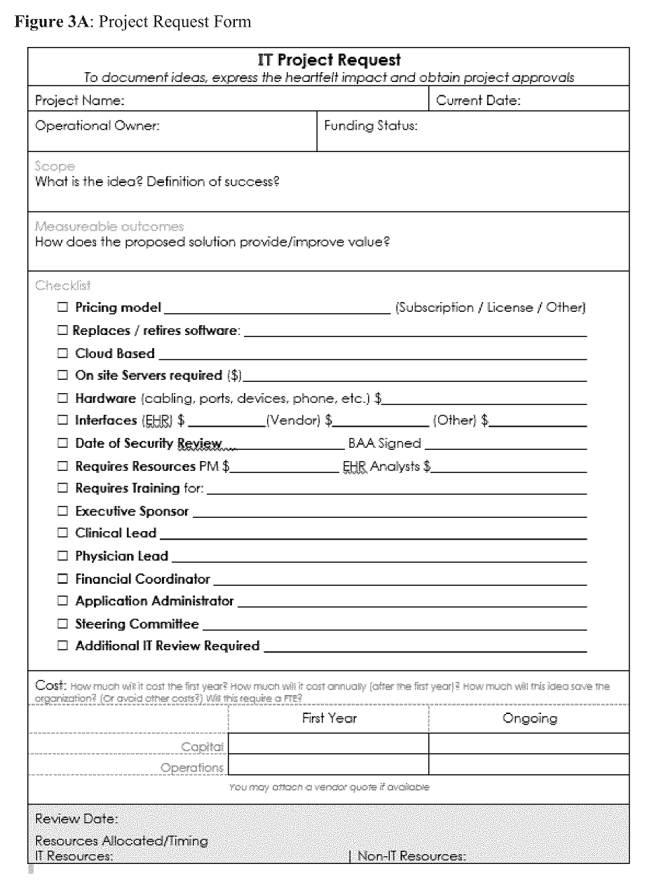

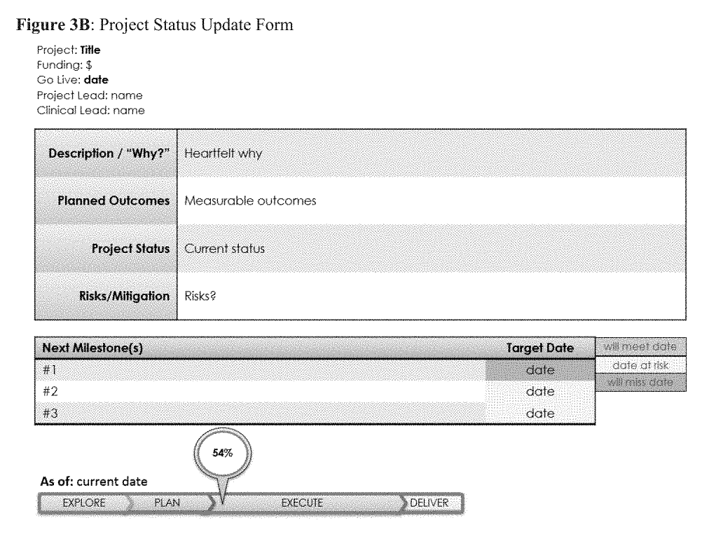

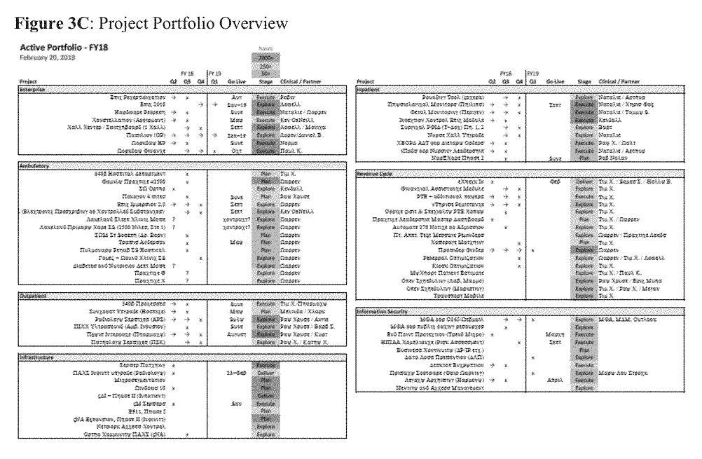

### Project Request Form is FIG. 3A

### Project Status Update Form is FIG. 3B

These tools are designed to keep the heartfelt why in the forefront of all conversations. This ability to put forward the end result helps keep team members motivated and is a great reminder about how this project supports/improves patient care.

The 1-page project portfolio overview aids in the discussion of workload and possible tradeoffs in prioritization discussions.

Project Portfolio overview is FIG. 3C.

1. A project management process that keeps the heartfelt why at the forefront of ensuing conversations and project implementation
a. A four-phase process that supports specific, value-based conversations and
b. Supporting documents to improve communication around project intake and implementation.
